(19) United States
(12) Patent Application Publication
(10) Pub. No.: US 2005/0001354 A1
(43) Pub. Date: Jan. 6, 2005

(54) Process for the production of a composite article

(76) Inventor: Martin Klocke, Koln (DE)

Correspondence Address: BAYER MATERIAL SCIENCE LLC, 100 BAYER ROAD, PITTSBURGH, PA, 15205, US

(21) Appl. No.: 10/879,799

(22) Filed: Jun. 29, 2004

(30) Foreign Application Priority Data
Jul. 2, 2003 (DE) 10329710.3

(51) Int. Cl. B29C 45/14

(52) U.S. Cl. 264/279; 264/570; 264/328.18

(57) ABSTRACT

A process for preparing a composite hollow body article by means of injection molding is disclosed. The process includes the steps of: (a) providing a hollow body (2) having exterior surfaces (10) and interior surfaces (14), the interior surfaces (14) of the hollow body (2) defining a hollow interior (17), the hollow body (2) also having at least one opening (4, 4′) which provides fluid communication with the hollow interior (17) thereof, (b) introducing a substantially incompressible fluid (23) into the hollow interior (17) of the hollow body (2), the hollow interior (17) being substantially filled with the substantially incompressible fluid (23); and (c) injection molding thermoplastic material (3, 3′, 3″) onto at least a portion of the exterior surfaces (10) of the hollow body (2).

### CROSS REFERENCE TO RELATED PATENT APPLICATION

The present patent application claims the right of priority under 35 U.S.C. §119 (a)-(d) of German Patent Application No. 103 29 710.3, filed Jul. 2, 2003.

### FIELD OF THE INVENTION

The invention relates to a process for the production of a plastics/metal or plastics/plastics composite article that includes a hollow body made of metal or plastics material which has at least one opening and onto which and/or around part or all of which thermoplastic plastics material is injection molded. During the injection molding process, the hollow interior of the hollow body is filled with a substantially incompressible fluid.

### BACKGROUND OF THE INVENTION

Hollow-chamber composite components, consisting of a shell and a covering plate, are known, for example, from DE-A 198 48 516. Integrally molded thermoplastic plastics material is used for joining the shell to the covering plate or covering shell. For that purpose, the shell and the covering plate have, for example, a peripheral edge which is provided with perforations to which there are attached, for example, riveted joints of integrally molded plastics material. Alternatively or additionally, it is also possible to provide beads, at which a shear-resistant, positive-locking joint can likewise be produced by means of integrally molded plastics material. Other methods of joining two or more shaped parts, such as welding, adhesive bonding, crimping, clinching, riveting, which can be used individually or in combination for the joining of shaped parts, are also known from DE-A 198 48 516.

Hollow-chamber lightweight components which can be subjected to high mechanical loads are used, for example, in motor vehicle construction.

When thermoplastic plastics material is injection molded around a hollow body or when shaped parts are injection molded onto a hollow body in order to produce a hollow-chamber composite component, the injection pressure is so high that the hollow body becomes greatly deformed or collapses. In order to avoid the plastic deformation of hollow bodies during injection molding of the plastics material, it is known to support the hollow body from the inside by means of cores, sliders or the like. However, that is only possible with hollow bodies of simple geometry, e.g. straight or uniformly curved tubes having a constant diameter. Hollow bodies of any desired geometry, for example those which are angled, branched or non-uniformly curved with different diameters, e.g. tubes having necks or tapered portions, cannot be supported against the injection pressure by means of sliders which are introduced into the hollow body through openings.

### SUMMARY OF THE INVENTION

The object of the present invention is to provide a process for the production of a plastics/metal composite component which consists at least of a hollow body made of metal or plastics material, in which process the hollow body does not become deformed when thermoplastic plastics material is injection molded onto and/or around it.

In accordance with the present invention, there is provided a process of preparing a composite article comprising:
(a) providing a hollow body (2) having exterior surfaces (10) and interior surfaces (14), the interior surfaces (14) of said hollow body (2) defining a hollow interior (17), said hollow body (2) also having at least one opening (4, 4′) which provides fluid communication with the hollow interior (17) of said hollow body (2);
(b) introducing a substantially incompressible fluid (23) into the hollow interior (17) of said hollow body (2) by means of said opening (4, 4′), the hollow interior (17) being substantially filled with said substantially incompressible fluid (23); and
(c) injection molding thermoplastic material (3, 3′, 3″) onto at least a portion of the exterior surfaces (10) of said hollow body (2), e.g., thermoplastic material may be injection molded around a portion of exterior surfaces (10) of hollow body (2).

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions used in the specification and claims are understood as modified in all instances by the term “about.”

### BRIEF DESCRIPTION OF THE DRAWINGS

FIG. 1 is a representative perspective view of a composite article produced in accordance with the process of the present invention; and

FIG. 2 is a sectional representation of the composite article of FIG. 1 within an injection molding tool or unit.

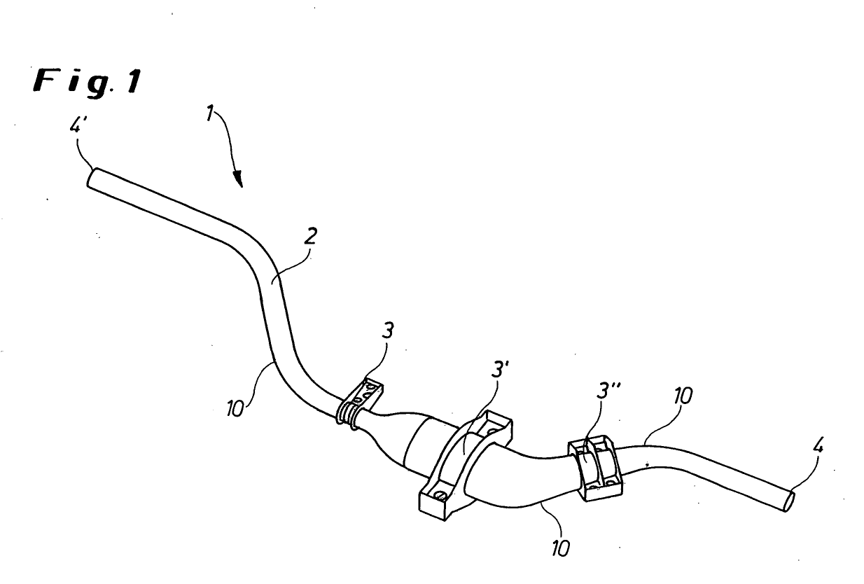

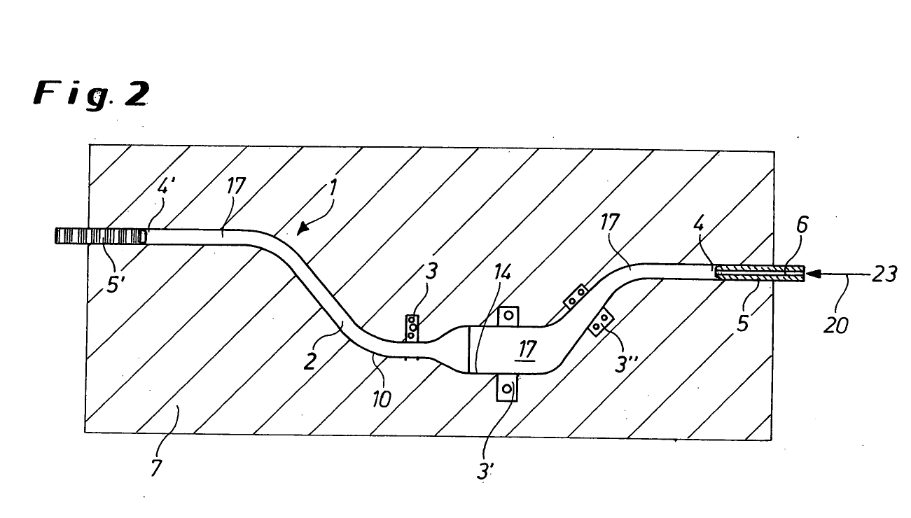

In FIGS. 1 and 2, like reference numerals designate the same components and structural features.

### DETAILED DESCRIPTION OF THE INVENTION

The incompressible fluid with which the hollow body is filled according to the invention when the thermoplastic plastics material is injection molded onto or around the hollow body prevents plastic deformation of the hollow body by the injection pressure. The incompressible fluid provides the necessary counter-pressure to the injection pressure. In a preferred embodiment of the process according to the invention, a positive pressure of less than or equal to 130 bar is applied to the incompressible fluid (e.g., a pressure of from 1 bar to 130 bar).

The incompressible fluid may be, for example, water, a water/oil mixture, especially an oil-in-water emulsion, a water/glycol mixture or a (mineral) oil. Such fluids are known, for example, as hydraulic fluids of category HFA (oil-in-water emulsions or solutions, which contain more than 80% water), HFB (water-in-oil emulsions having a water content of about 45%) and HFC (polymer/water or water/glycol mixture having a water content of at least 35%). It is additionally possible to use electroviscous or magnetoviscous fluids.

The hollow body has at least one opening through which the incompressible fluid is supplied (or introduced into the hollow interior thereof) before the plastics material is molded on and is optionally conveyed away again after the injection molding step is completed. The hollow body is preferably filled with the fluid after the hollow body has been placed into the injection-molding tool. However, it is also possible for the filled hollow body to be placed into the injection-molding tool. When the hollow body has been filled with the fluid, the opening is closed by closing (preferably reversible closing) means, such as a cap, stopper or the like.

After injection molding of thermoplastic material onto at least a portion of the exterior surfaces of the hollow body, the incompressible fluid may be left in the hollow interior of the hollow body. Preferably, after the injection molding step, the incompressible fluid is removed from the hollow interior of the hollow body.

The hollow body may be of any desired shape. It may in particular also be branched, angled, curved, round or may have comers, because any shape can be filled by the incompressible fluid. The hollow body is preferably a hollow body in one piece (a unitary hollow body), i.e., the hollow body is closed on all sides with the exception of at least one opening. If the hollow body is in several pieces, the joints between the shaped parts must be fluid-tight. That can be achieved, for example, by joining the shaped parts together by means of a tight connection, e.g. by welding, adhesive bonding or by a cold-joining process, especially in the case of shaped parts made of aluminium. If the shaped parts are not joined together in a fluid-tight manner, for example are joined by clamping, screwing or by deformation of the material, then seals may also be provided.

Preferred metals from which the hollow body may be fabricated include steel, nickel, chromium, iron, copper, zinc, titanium, aluminum and magnesium and also alloys of those metals.

Preferred plastics materials from which the hollow body may be fabricated include unreinforced, reinforced and/or filled thermoplastic plastics materials, e.g. polycarbonate (PC), thermoplastic polyurethane (PU), polyester, especially polyethylene terephthalate (PET), polystyrene (PS), syndiotactic polystyrene, acrylonitrile-butadiene-styrene (ABS), polypropylene oxide (PPO), polysulfone (PSO), polyphenylene sulfide (PPS), polyimide (PI), polyketone (PEEK), polyamide (PA), polybutylene terephthalate (PBT), polypropylene (PP), polyethylene (PE) or a mixture of those plastics materials.

The hollow body may have a wide range of wall thicknesses. Typically, the hollow body has a wall thickness of from 1 to 3 mm.

As the thermoplastic plastics material for injection molding onto or around the hollow body there is suitable especially an unreinforced, reinforced and/or filled plastics material based on polyamide (PA), polyester, especially polyethylene terephthalate (PET), polybutylene terephthalate (PBT), polystyrene (PS), syndiotactic polystyrene, acrylonitrile-butadiene-styrene (ABS), polybutylene terephthalate (PBT), thermoplastic polyurethane .(PU), polyolefin, especially polypropylene (PP), polyethylene (PE), polycarbonate (PC), polypropylene oxide (PPO), polysulfone (PSO), polyphenylene sulfide (PPS), polyimide (PI), polyether ether ketone (PEEK) or a mixture of those plastics materials.

The thermoplastic material of the hollow body and the thermoplastic material injection molded onto the exterior surfaces of the hollow body may each independently include a reinforcing material. Reinforcing materials that may be used include, for example, glass fibers, glass beads, carbon fibers, metal flakes, polyamide fibers, nanoparticulate materials (e.g., having average particle sizes in the range of from 1 nm to 1000 nm, such as nanoparticulate clays), talc and mixtures thereof. The reinforcing fibers, and the glass fibers in particular, may have sizings on their surfaces to improve miscibility and/or adhesion to the plastics into which they are incorporated, as is known to the skilled artisan. Glass fibers are a preferred reinforcing material in the present invention. If used, the reinforcing material, e.g., glass fibers, is typically present in the thermoplastic materials in a reinforcing amount, e.g., in an amount of from 5 percent by weight to 60 percent by weight, based on the total weight of the thermoplastic plastic material of the particular element (e.g., the hollow body or the injected-on thermoplastic material).

The thermoplastic material of the hollow body and the thermoplastic material injection molded onto the exterior surfaces of the hollow body may each independently further include one or more functional additives other than or in addition to the reinforcing materials. Additives that may be used include, but are not limited to, antioxidants, colorants, e.g., pigments and/or dyes, mold release agents, fillers (e.g., calcium carbonate and barium sulfate), ultraviolet light absorbers, fire retardants and mixtures thereof. Additives may be present in the thermoplastic materials in functionally sufficient amounts, e.g., in amounts independently from 0.1 percent by weight to 10 percent by weight, based on the total weight of the thermoplastic plastic material of the particular element (e.g., the hollow body or the injected-on thermoplastic material).

By supporting the hollow body (from within) with an incompressible fluid, it is possible to injection mold thermoplastic plastics material onto or around hollow bodies. It is no longer necessary to support the hollow body against the injection pressure by means of fixed and/or solid internal support elements in order to avoid plastic deformation or collapse of the hollow body.

Examples of composite articles that may be prepared in accordance with the present invention include, but are not limited to articles used as lightweight components in automotive construction, e.g. cross car beams or cross members.

The invention is explained in greater detail below with reference to the accompanying drawings.

FIG. 1 shows a metal/plastics composite article 1 which has been produced by the process according to the invention. The composite article 1 includes a tubular hollow body 2 made of metal. The hollow body 2 has curved portions. The hollow body 2 has different diameters at different points. The hollow body 2 has two openings 4, 4′. In the regions 3, 3′, 3″, thermoplastic plastics material has been injection molded onto a portion of exterior surface 10 of and around the hollow body 2. The elements 3, 3′, 3″ which have been injection molded onto a portion of exterior surface 10 and around the hollow body 2 constitute functional elements, e.g., that may be used to attach composite article 1 to another structure, such as the under carriage of a motor vehicle (not shown).

FIG. 2 shows the metal/plastics composite article 1 in an injection-molding tool 7 in longitudinal section. When the injection-molding tool has been closed and before the incompressible fluid is introduced, the hollow body 2 is closed at its openings 4, 4′ by means of stopper-like sliders 5, 5′. Hollow body 2 has interior surfaces 14 which define hollow interior 17. The slider 5 has a bore 6 through which the incompressible fluid 23 is fed into the hollow body (as represented by arrow 20). During filling, the sliders 5, 5′ do not provide a complete seal, so that the enclosed air is able to escape. When the hollow body 2 is completely full, it is closed completely by means of the sliders 5, 5′. As a result of the complete closure, pressure builds up in the hollow body. Filling and emptying of the hollow body 2 may be carried out by means of a hydraulic control (not shown) which controls the pressure, the direction of flow and the stopping of the flow.

### EXAMPLES

### Example 1 (comparison example)

A tubular hollow body 2 made of sheet steel and having a diameter of 100 mm and a sheet thickness of 2 mm was inserted into the injection-molding tool 7. In the regions 3, 3′, 3″, glass-fibre-reinforced polyamide 6 (PA 6 GF30) was injection molded onto a portion of exterior surfaces 10 and around the hollow body 2 in an annular manner along the periphery over a width of 40 mm. The thickness of the layer of injected-on plastics material was 3 mm. Hollow body 2 was not filled with an incompressible fluid prior to the injection molding step. The hollow body underwent plastic deformation when the thermoplastic plastics material was injection molded around it. The steel sheet walls of hollow body 2 were pressed in by about 30 mm. The resulting comparative plastics/metal composite article could not be used for the intended purpose (e.g., as a conduit).

### Example 2 (implementation example)

A hollow body 2 as described in Example 1 was filled with oil 23 after being placed in the injection-molding tool 7 (and prior to the injection molding step). A pressure of about 90 bar was applied to the fluid. Glass-fiber-reinforced polyamide 6 (PA 6 GF30) was then injection molded onto a portion of exterior surfaces 10 and around the hollow body 2 under an injection pressure and conditions substantially similar to those used in Example 1. The incompressible fluid provided a sufficiently high counter-pressure to the injection pressure, so that deformation of steel sheet walls of hollow body 2 was less than 1 mm. The plastic deformation was so greatly reduced that the resulting plastics/metal composite article 1 (according to the invention) was able to assume all structural functions according to the intended purpose (e.g., as a conduit).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process of preparing a composite article comprising:
(a) providing a hollow body having exterior surfaces and interior surfaces, the interior surfaces of said hollow body defining a hollow interior, said hollow body also having at least one opening which provides fluid communication with the hollow interior of said hollow body;
(b) introducing a substantially incompressible fluid into the hollow interior of said hollow body by means of said opening in said hollow body, the hollow interior being substantially filled with said substantially incompressible fluid; and
(c) injection molding thermoplastic material onto at least a portion of the exterior surfaces of said hollow body.

2. The process of claim 1 wherein said incompressible fluid has a positive pressure of less than or equal to 130 bar.

3. The process of claim 1 wherein said incompressible fluid is selected from the group consisting of water, oil and combinations thereof.

4. The process of claim 3 wherein said incompressible fluid is a water/oil mixture selected from the group consisting of an oil-in-water mixture and a water-in-oil mixture.

5. The process of claim 3 wherein said incompressible fluid is a water/glycol mixture.

6. The process of claim 1 wherein said hollow body is fabricated from a material selected from the group consisting of steel, nickel, chromium, iron, copper, zinc, titanium, aluminum, magnesium and alloys thereof.

7. The process of claim 1 wherein said hollow body is fabricated from a material selected from the group consisting of: thermoplastic material; and thermoplastic material containing a member selected from the group consisting of reinforcing material, filler and combinations thereof.

8. The process of claim 7 wherein said thermoplastic material is selected from the group consisting of polycarbonate (PC), thermoplastic polyurethane (PU), polyester, polystyrene (PS), syndiotactic polystyrene, acrylonitrile-butadiene-styrene (ABS), polypropylene oxide (PPO), polysulfone (PSO), polyphenylene sulfide (PPS), polyimide (PI), polyketone (PEEK), polyamide (PA), polybutylene terephthalate (PBT), polypropylene (PP), polyethylene (PE) and combinations thereof.

9. The process of claim 1 wherein the thermoplastic material that is injection molded onto at least a portion of the exterior surfaces of said hollow body optionally comprises a material selected from the group consisting of reinforcing material, filler material and combinations thereof.

10. The process of claim 9 wherein said thermoplastic material is selected from the group consisting of polyamide (PA), polyester, polybutylene terephthalate (PBT), polystyrene (PS), syndiotactic polystyrene, acrylonitrile-butadiene-styrene (ABS), polybutylene terephthalate (PBT), thermoplastic polyurethane (PU), polyolefin, especially polypropylene (PP), polyethylene (PE), polycarbonate (PC), polypropylene oxide (PPO), polysulfone (PSO), polyphenylene sulfide (PPS), polyimide (PI), polyether ether ketone (PEEK) and combinations thereof.

11. The process of claim 1 wherein said incompressible fluid is removed from the hollow interior of said hollow body after injection molding step (c).
